(19) United States
(12) Patent Application Publication
(10) Pub. No.: US 2026/0342636 A1
(43) Pub. Date: Oct. 29, 2026

(54) COMMUNICATION METHOD AND APPARATUS

(71) Applicant: HUAWEI TECHNOLOGIES CO., LTD., Shenzhen (CN)

(72) Inventors: Huiyang Qu, Chengdu (CN); Huang Huang, Chengdu (CN)

(73) Assignee: HUAWEI TECHNOLOGIES CO., LTD., Shenzhen (CN)

(21) Appl. No.: 19/550,999

(22) Filed: Feb. 26, 2026

Related U.S. Application Data
(63) Continuation of application No. PCT/CN2023/115343, filed on Aug. 28, 2023.

(51) Int. Cl. H04L 27/26; H04L 1/00

(52) U.S. Cl. CPC H04L 27/2666; H04L 1/0003

(57) ABSTRACT

This application discloses a communication method and apparatus. The method includes: A transmit end determines a length of a guard interval sequence based on a first parameter including at least one of: a number of valid subcarriers in a scheduled bandwidth, an inverse fast Fourier transform (IFFT) length, a modulation and coding scheme (MCS), or a ratio of a number of occupied subcarriers to the number of valid subcarriers; generates a first symbol sequence including the guard interval sequence, and the first symbol sequence is a symbol sequence prior to transform precoding; and outputs the first symbol sequence.

### CROSS-REFERENCE TO RELATED APPLICATIONS

This application is a continuation of International Application No. PCT/CN2023/115343, filed on Aug. 28, 2023, the disclosure of which is hereby incorporated by reference in its entirety.

### TECHNICAL FIELD

This application relates to the field of communication technologies, and in particular, to a communication method and apparatus.

### BACKGROUND

In a radio channel, multipath delay and fading cause inter-symbol interference (ISI) at a signal receive end. In a multicarrier system, a guard interval (GI) is typically inserted between time domain symbols to eliminate ISI therebetween. For example, a symbol sequence at the end of each time domain symbol may be copied to the beginning of the time domain symbol, to form a guard interval that includes transmission information.

For a single carrier system, a reference signal and data may be multiplexed into a same time domain symbol in a time-division manner, and the guard interval may be set in the time domain symbol. However, how to determine a length of the guard interval sequence in the time domain symbol still needs to be further studied.

### SUMMARY

This application provides a communication method and apparatus, to determine a length of a guard interval sequence in a time domain symbol based on a first parameter, which helps reduce multipath delay interference in a single carrier system and improve transmission performance of the single carrier system.

According to a first aspect, this application provides a communication method. The method may be applied to a transmit end, a processor in the transmit end, a chip or a chip system, a functional module, or the like. An example in which the method is applied to the transmit end, and the transmit end is a terminal device is used. Unless otherwise specified, the “terminal device” may be the terminal device itself, or may be a component in the terminal device, for example, a system-on-a-chip (SoC). In the method, the terminal device determines a length of a guard interval sequence based on a first parameter, where the first parameter includes at least one of the following: a number of valid subcarriers in a scheduled bandwidth, an inverse fast Fourier transform (IFFT) length, a modulation and coding scheme (MCS), and a ratio of a number of occupied subcarriers to the number of valid subcarriers; generates a first symbol sequence, where the first symbol sequence includes the guard interval sequence, and the first symbol sequence is a symbol sequence prior to transform precoding; and outputs the first symbol sequence.

According to the foregoing method, when determining the length of the guard interval sequence, the terminal device considers parameters in different dimensions such as the number of valid subcarriers in the scheduled bandwidth, the inverse fast Fourier transform (IFFT) length, the modulation and coding scheme (MCS), and the ratio of the number of occupied subcarriers to the number of valid subcarriers. This helps reduce multipath delay interference in a single carrier system based on the guard interval sequence, and improve transmission performance of the single carrier system.

In an embodiment, the method further includes: processing the first symbol sequence to obtain a third symbol sequence and a cyclic prefix sequence of the third symbol sequence; and outputting the third symbol sequence and the cyclic prefix sequence of the third symbol sequence, where the processing includes transform precoding, an IFFT, and adding the cyclic prefix sequence of the third symbol sequence.

In an embodiment, determining the length of the guard interval sequence based on the first parameter includes: determining the length of the guard interval sequence based on a first length, the number of valid subcarriers, the IFFT length, and an extension length. The first length is a first preset value, or the first length is determined based on the IFFT length. The extension length is a second preset value, or the extension length is determined based on at least one of the following: the MCS, a ratio of the number of valid subcarriers to the IFFT length, and the ratio of the number of occupied subcarriers to the number of valid subcarriers.

In this way, because a signal processing procedure in the single carrier system usually uses a shaped pulse and is accompanied by oversampling, a receive end needs to perform corresponding undersampling, leading to a multipath delay dispersion phenomenon exists. In embodiments of this application, the extension length is introduced to further increase the length of the guard interval sequence, which helps reduce interference caused by multipath delay dispersion.

In an embodiment, the length of the guard interval sequence satisfies the following formula: L=floor(a*M/N)+2Q or L=ceiling(a*M/N)+2Q.

L represents the length of the guard interval sequence, a represents the first length, M represents the number of valid subcarriers, N represents the IFFT length, Q represents the extension length, floor represents rounding down, and ceiling represents rounding up.

In an embodiment, the first symbol sequence further includes a second symbol sequence, and the second symbol sequence is either a reference signal symbol sequence or a data symbol sequence. The guard interval sequence is a first guard interval sequence; the guard interval sequence is a second guard interval sequence; or the guard interval sequence includes the first guard interval sequence and the second guard interval sequence. The first guard interval sequence is located before the second symbol sequence, and the second guard interval sequence is located after the second symbol sequence.

In an embodiment, the first guard interval sequence is a cyclic prefix sequence of the second symbol sequence, and the second guard interval sequence is a cyclic suffix sequence of the second symbol sequence.

In an embodiment, when the guard interval sequence includes the first guard interval sequence and the second guard interval sequence, a length of the first guard interval sequence is determined based on the first length, the number of valid subcarriers, the IFFT length, and the extension length, and a length of the second guard interval sequence is determined based on the extension length. Alternatively, the length of the second guard interval sequence is determined based on the first length, the number of valid subcarriers, the IFFT length, and the extension length, and the length of the first guard interval sequence is determined based on the extension length. The first length is the first preset value, or the first length is determined based on the IFFT length. The extension length is the second preset value, or the extension length is determined based on at least one of the following: the MCS, the ratio of the number of valid subcarriers to the IFFT length, and the ratio of the number of occupied subcarriers to the number of valid subcarriers.

In an embodiment, the method further includes: sending first indication information, where the first indication information indicates the length of the first guard interval sequence and/or the length of the second guard interval sequence.

In this way, the transmit end sends the first indication information, so that the receive end can learn of the length of the first guard interval sequence and/or the length of the second guard interval sequence.

In an embodiment, when the guard interval sequence includes the first guard interval sequence and the second guard interval sequence, the length of the first guard interval sequence or the length of the second guard interval sequence satisfies the following formula: L′=2Q−p.

L′ represents the length of the first guard interval sequence or the length of the second guard interval sequence, Q represents the extension length, p is less than or equal to 2Q, and p is an integer greater than or equal to 0. The extension length is the second preset value, or the extension length is determined based on at least one of the following: the MCS, the ratio of the number of valid subcarriers to the IFFT length, and the ratio of the number of occupied subcarriers to the number of valid subcarriers.

In an embodiment, the method further includes: sending second indication information, where the second indication information indicates an advance amount or a delay amount of a receive window of the second symbol sequence, and the advance amount or the delay amount is determined based on the length of the first guard interval sequence or the length of the second guard interval sequence, and the extension length; and the receive window is configured to take the second symbol sequence after inverse transform precoding.

In this way, the advance amount or the delay amount is determined based on the length of the first guard interval sequence or the length of the second guard interval sequence, and the extension length, which helps reduce interference caused by forward dispersion and backward dispersion.

In an embodiment, L′ represents the length of the first guard interval sequence. If p is greater than Q, the second indication information indicates that the delay amount of the receive window is p−Q. If p is less than Q, the second indication information indicates that the advance amount of the receive window is Q−p.

In an embodiment, L′ represents the length of the second guard interval sequence. If p is greater than Q, the second indication information indicates that the advance amount of the receive window is p−Q. If p is less than Q, the second indication information indicates that the delay amount of the receive window is Q−p.

According to a second aspect, this application provides a communication method. The method may be applied to a receive end, a processor in the receive end, a chip or a chip system, a functional module, or the like. An example in which the method is applied to the receive end, and the receive end is a network device is used. Unless otherwise specified, the “network device” may be the network device itself, or may be a component in the network device, for example, a system-on-a-chip SoC. In the method, the network device receives a signal; processes the signal to obtain a first symbol sequence, where the first symbol sequence includes a guard interval sequence, a length of the guard interval sequence is determined based on a first parameter, and the first parameter includes at least one of the following: a number of valid subcarriers in a scheduled bandwidth, an IFFT length, an MCS, and a ratio of a number of occupied subcarriers to the number of valid subcarriers; and obtains decoded data based on the first symbol sequence.

In an embodiment, the first symbol sequence further includes a second symbol sequence, and the second symbol sequence is either a reference signal symbol sequence or a data symbol sequence. The guard interval sequence is a first guard interval sequence; the guard interval sequence is a second guard interval sequence; or the guard interval sequence includes the first guard interval sequence and the second guard interval sequence. The first guard interval sequence is located before the second symbol sequence, and the second guard interval sequence is located after the second symbol sequence.

In an embodiment, the first guard interval sequence is a cyclic prefix sequence of the second symbol sequence, and the second guard interval sequence is a cyclic suffix sequence of the second symbol sequence.

In an embodiment, the method further includes: receiving first indication information, where the first indication information indicates the length of the first guard interval sequence and/or the length of the second guard interval sequence.

In an embodiment, the method further includes: receiving second indication information, where the second indication information indicates an advance amount or a delay amount of a receive window of the second symbol sequence; and the receive window is configured to take the second symbol sequence after inverse transform precoding.

The communication method provided in the second aspect corresponds to the communication method provided in the first aspect. For beneficial effects of related technical features in the second aspect, refer to the descriptions in the first aspect. Details are not described again.

According to a third aspect, this application provides a communication apparatus. The communication apparatus can implement functions in the first aspect or the second aspect. For example, the communication apparatus includes a corresponding module, unit, or means for performing operations in the first aspect or the second aspect. The module, unit, or means may be implemented by using software, may be implemented by using hardware, or may be implemented by hardware executing corresponding software.

In an embodiment, the communication apparatus includes a processing unit and a communication unit. The communication unit may be configured to receive and send a signal, to implement communication between the communication apparatus and another apparatus. For example, the communication unit is configured to send system information to a terminal. The processing unit may be configured to perform some internal operations of the communication apparatus. Functions performed by the processing unit and the communication unit may correspond to operations in the first aspect or the second aspect.

In an embodiment, the communication apparatus includes a processor, and the processor may be configured to be coupled to a memory. The memory may store a computer program or instructions necessary for implementing the functions in the first aspect or the second aspect. The processor may execute the computer program or the instructions stored in the memory. When the computer program or the instructions are executed, the communication apparatus is enabled to implement the method according to any embodiment of the first aspect or the second aspect.

In an embodiment, the communication apparatus includes a processor and a memory.

The memory may store a necessary computer program or necessary instructions to implement the functions in the first aspect or the second aspect. The processor may execute the computer program or the instructions stored in the memory. When the computer program or the instructions are executed, the communication apparatus is enabled to implement the method according to any embodiment of the first aspect or the second aspect.

In an embodiment, the communication apparatus includes a processor and an interface circuit. The processor is configured to communicate with another apparatus via the interface circuit, and perform the method according to any embodiment of the first aspect or the second aspect.

It may be understood that in the third aspect, the processor may be implemented by hardware or software. When the processor is implemented by the hardware, the processor may be a logic circuit, an integrated circuit, or the like. When the processor is implemented by the software, the processor may be a general-purpose processor, and is implemented by reading software code stored in the memory. In addition, there may be one or more processors, and one or more memories. The memory may be integrated with the processor, or the memory and the processor are disposed separately. In an embodiment, the memory and the processor may be integrated into a same chip, or may be disposed on different chips. A type of the memory and a manner in which the memory and the processor are disposed are not limited in embodiments of this application.

According to a fourth aspect, this application provides a communication system. The communication system may include a first communication apparatus and a second communication apparatus. The first communication apparatus is configured to perform the method according to the first aspect, and the second communication apparatus is configured to perform the method according to the second aspect.

According to a fifth aspect, this application provides a computer-readable storage medium. The computer storage medium stores a computer program (or computer-readable instructions), and when a computer reads and executes a part or all of the computer-readable instructions, the method according to any embodiment of the first aspect or the second aspect is performed.

For example, the computer-readable storage medium may be any available medium accessible to the computer. As an example rather than a limitation, the computer-readable medium may include a non-transitory computer-readable medium, a random-access memory (RAM), a read-only memory (ROM), an electrically erasable programmable read-only memory (EEPROM), a CD-ROM or another optical disk storage, a magnetic disk storage medium or another magnetic storage device, or any other medium that can be used to carry or store desired program code in a form of instructions or a data structure and that can be accessed by the computer.

According to a sixth aspect, this application provides a computer program product.

When a computer reads and executes the computer program product, to enable the method according to any embodiment of the first aspect or the second aspect to be performed.

According to a seventh aspect, this application provides a chip (or a chip system). The chip includes a processor. The processor is coupled to a memory, and the memory stores a computer program. The processor is configured to invoke a part or all of the computer program in the memory, to enable the method according to any embodiment of the first aspect or the second aspect to be performed.

### BRIEF DESCRIPTION OF DRAWINGS

FIG. 1 is a diagram of a communication system to which an embodiment of this application is applicable;

FIG. 2 is a diagram of channel multipath delay distribution according to an embodiment of this application;

FIG. 3 is a diagram of an example structure of a time domain symbol of a multicarrier system according to an embodiment of this application;

FIG. 4A is a diagram of an example signal processing procedure according to an embodiment of this application;

FIG. 4B is a diagram of an example structure of a time domain symbol of a single carrier system according to an embodiment of this application;

FIG. 5 is a schematic flowchart corresponding to a communication method according to an embodiment of this application;

FIG. 6 is a diagram of multipath delay dispersion according to an embodiment of this application;

FIG. 7 is a diagram of a receive window according to an embodiment of this application;

FIG. 8 is an example block diagram of an apparatus according to an embodiment of this application; and

FIG. 9 is a diagram of a structure of a communication apparatus according to an embodiment of this application.

### DETAILED DESCRIPTION

The following describes the technical solutions in embodiments of this application with reference to the accompanying drawings in embodiments of this application. The technical solutions in embodiments of this application may be applied to various communication systems, such as a universal mobile telecommunications system (UMTS), a wireless local area network (WLAN), a wireless fidelity (Wi-Fi) system, a 4th generation (4G) mobile communication system, for example, a long term evolution (LTE) system, a 5th generation (5G) mobile communication system, for example, a new radio (NR) system, and a future evolved communication system, for example, a 6th generation (6G) mobile communication system.

Particularly, embodiments of this application may be applied to a scenario in which high-frequency phase noise is severe. This application may be applied to the following scenarios: enhanced mobile broadband (eMBB), multi-station transmission (a same terminal device transmits a signal to a plurality of stations), a backhaul scenario, wireless to the x (WTTx), device-to-device (D2D), or another scenario that has a high requirement on timing or a high requirement on a transmission rate.

All aspects, embodiments, or features are presented in this application by describing a system that may include a plurality of devices, components, modules, and the like. It should be appreciated and understood that each system may include another device, component, module, and the like, and/or may not include all devices, components, modules, and the like discussed with reference to the accompanying drawings. In addition, a combination of these solutions may be used. In addition, in embodiments of this application, terms such as “example” and “for example” are used to give an example, an illustration, or a description. Any embodiment or design scheme described as an “example” in this application should not be explained as being more preferred or having more advantages than another embodiment or design scheme. Exactly, the term “example” is used to present a concept in a specific manner. In embodiments of this application, “of”, “corresponding, relevant”, and “corresponding” may be interchangeably used sometimes. It should be noted that meanings expressed by the terms are consistent when differences are not emphasized.

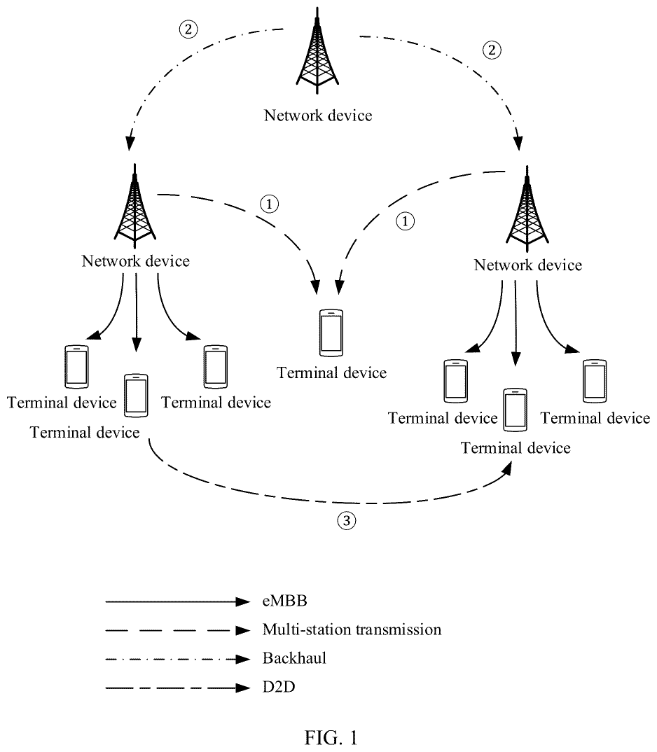

For ease of understanding of embodiments of this application, a communication system shown in FIG. 1 is first used as an example to describe in detail a communication system applicable to embodiments of this application. As shown in FIG. 1, the communication system may include one or more network devices and one or more terminal devices. An interface between the network device and the terminal device may be a Uu interface (or referred to as an air interface), and data transmission may be performed between the network device and the terminal device via an air interface resource.

FIG. 1 shows an example of a scenario to which an embodiment of this application is applicable, e.g., eMBB (shown by a solid line in FIG. 1), multi-station transmission (shown by a dashed line \textcircled{1} in FIG. 1), a backhaul scenario (shown by a dashed line \textcircled{2} in FIG. 1), and D2D (shown by a dashed line \textcircled{3} in FIG. 1). It should be understood that the four scenarios shown in FIG. 1 are merely examples. This is not limited in embodiments of this application.

In an embodiment, the network device may be a base station, an evolved NodeB (eNodeB), an access point (AP), a transmission reception point (TRP), a next generation NodeB (gNB), a next generation base station in a 6G mobile communication system, a base station in a future mobile communication system, an access node in a Wi-Fi system, or the like. The network device may be a macro base station, a micro base station, an indoor base station, a relay node, or a donor node, or a radio controller in an open radio access network (open RAN, O-RAN, or ORAN) or a cloud radio access network (CRAN) scenario. In an embodiment, the network device may alternatively be a server, a wearable device, a vehicle, a vehicle-mounted device, or the like. For example, the network device in a vehicle to everything (V2X) technology may be a road side unit (RSU). All or a part of functions of the network device in this application may alternatively be implemented by using a software function running on hardware, or may be implemented by using an instantiated virtualization function on a platform (for example, a cloud platform). The network device in this application may alternatively be a logical node, a logical module, or software that can implement all or a part of functions of the network device.

In another embodiment, a plurality of network devices collaborate to assist the terminal device in implementing wireless access, and different network devices separately implement some base station functions. For example, the network device may be a central unit (CU), a distributed unit (DU), a CU-control plane (CP), a CU-user plane (UP), a radio unit (RU), or the like. The CU and the DU may be separately arranged, or may be included in a same network element, for example, a baseband unit (BBU). The RU may be included in a radio frequency device or a radio frequency unit, for example, included in a remote radio unit (RRU), an active antenna unit (AAU), or a remote radio head (RRH).

In different systems, the CU (or the CU-CP and the CU-UP), the DU, or the RU may also have different names, but a person skilled in the art may understand meanings thereof. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP or the CU-UP), the DU, and the RU in this application may be implemented by using a software module, a hardware module, or a combination of a software module and a hardware module.

The terminal device may also be referred to as user equipment (UE), a terminal device, a user apparatus, an access terminal, a subscriber unit, a subscriber station, a mobile station, a mobile station (MS), a remote station, a remote terminal, a mobile device, a user terminal, a terminal unit, a terminal station, a terminal apparatus, a wireless communication device, a user agent, or a user device.

For example, the terminal device in embodiments of this application may be a mobile phone, a personal digital assistant (PDA) computer, a laptop computer, a tablet computer (Pad), an unmanned aerial machine, a computer with wireless receiving and sending functions, a machine type communication (MTC) terminal device, a virtual reality (VR) terminal device, an augmented reality (AR) terminal device, an internet of things (IoT) terminal device, a wireless terminal device in industrial control, a wireless terminal device in self driving, a wireless terminal device in telemedicine (remote medical), a wireless terminal device in a smart grid, a wireless terminal device in transportation safety, a wireless terminal device in a smart city, a wireless terminal device (for example, a game machine, a smart television, a smart speaker, a smart refrigerator, or fitness equipment) in a smart home, a vehicle-mounted terminal device, or an RSU having a function of a terminal device.

In embodiments of this application, unless otherwise specified, the “terminal device” may be the terminal device itself, or may be a component in the terminal device, for example, a system-on-a-chip (SoC), and the “network device” may be the network device itself, or may be a component in the network device, for example, the SoC.

In addition, the network device and the terminal may be deployed on the land, including an indoor device, an outdoor device, a handheld device, or a vehicle-mounted device, may be deployed on the water surface, or may be deployed on a plane, a balloon, and an artificial satellite in the air. Application scenarios of the network device and the terminal device are not limited in embodiments of this application.

The communication system and the service scenario described in embodiments of this application are intended to describe the technical solutions in embodiments of this application more clearly, and do not constitute a limitation on the technical solutions provided in embodiments of this application. A person of ordinary skill in the art may know that: With evolution of a network architecture and emergence of new scenarios, the technical solutions provided in embodiments of this application are also applicable to similar technical problems.

The following first explains and describes related terms in embodiments of this application. Unless otherwise specified, these explanations are intended to support meanings of related terms, for ease of understanding of embodiments of this application, and should not be considered as strict limitations on related terms in the protection scope claimed in this application.

### (1) Fourier Transform

The Fourier transform is one of the most important tools for signal processing in a communication system, and is used to implement conversion of a signal between time domain and frequency domain.

Common Fourier transforms include a discrete Fourier transform (DFT), a fast Fourier transform (FFT), an inverse discrete Fourier transform (IDFT), and an inverse fast Fourier transform (IFFT).

The DFT converts a time domain sequence into a frequency domain sequence, and the FFT is a method for quickly calculating the DFT. The IDFT converts a frequency domain sequence into a time domain sequence, and the IFFT is a method for quickly calculating the IDFT.

### (2) Cyclic Prefix/Cyclic Suffix

For a signal (or a sequence) S whose length is N, for example, S=[s_1, s_2, . . . , s_N], the cyclic prefix (CP) is formed by taking last L elements (L represents a length of the CP) of the sequence S, and adding a taken sequence whose length is L to the beginning of the original sequence S. The sequence with the CP added is S_CP=[s_N-L, s_N-L+1, . . . , s_N, s_1, s_2, . . . S_N], where the CP is [s_N-L, s_N-L+1, . . . , s_N].

For a signal (or a sequence) S whose length is N, for example, S=[s_1, s_2, . . . , s_N], the cyclic suffix (CS) is formed by taking first L elements (L represents a length of the CS) of the sequence S, and adding a taken sequence whose length is L to the end of the original sequence S. The sequence with the CS added is S_CS=[s_1, s_2, . . . , S_N, s_1, s_2, . . . , s_L], where the CS is [s_1, s_2, . . . , s_L].

### (3) Spectrum Spreading

In a case of no spectrum spreading, for quadrature amplitude modulation (QAM) modulation (or further rotated QAM), when there are N modulation symbols, N subcarriers are correspondingly allocated for transmission. Through spectrum spreading, e.g., increasing a number of subcarriers, a lower peak-to-average power ratio (PAPR) or a lower block error rate (BLER) can be obtained. Corresponding costs are that more frequency resources are occupied and spectrum efficiency is reduced.

A magnitude of spectrum spreading is usually represented by a roll-off factor α. A value of the roll-off factor α is defined as follows: number of transmitted subcarriers/number of QAM modulation symbols—1, transmit signal bandwidth/QAM symbol rate—1, or transmit signal bandwidth/Nyquist bandwidth for a signal—1. The number of transmitted subcarriers may also be referred to as a number of occupied subcarriers, and the number of QAM modulation symbols is equal to a number of valid subcarriers in a scheduled bandwidth.

Alternatively, the magnitude of spectrum spreading may also be represented by a spectrum spreading factor β. The spectrum spreading factor β is defined as: (number of transmitted subcarriers−number of QAM modulation symbols)/number of transmitted subcarriers, (transmit signal bandwidth−QAM symbol rate)/transmit signal bandwidth, or (transmit signal bandwidth-Nyquist bandwidth for a signal)/transmit signal bandwidth.

### (4) Oversampling and Undersampling

Oversampling may also be referred to as upsampling, e.g., increasing a number of samples. Undersampling may also be referred to as downsampling, e.g., reducing a number of samples.

When a waveform used for communication between a transmit end and a receive end is a single carrier waveform, the transmit end may perform oversampling in a signal processing process, and correspondingly, the receive end may perform undersampling in the signal processing process. For example, a number of valid subcarriers in a scheduled bandwidth is 256, and after oversampling is performed, an output IFFT length may be 1024, and an oversampling factor may be equal to a ratio of the IFFT length to the number of valid subcarriers, e.g., 1024/256=4. The IFFT length may be equal to a sampling rate/a subcarrier width, and the IFFT length may be an integer power of 2, 3, 5, or 7.

### (5) Power Delay Profile

A radio channel has a multipath effect. Due to phenomena of refraction, reflection, and the like of a building, a radio signal may arrive at a receive end through a plurality of paths during propagation. Because propagation distances of different paths are different, time for the signal to arrive at the receive end through different paths is different.

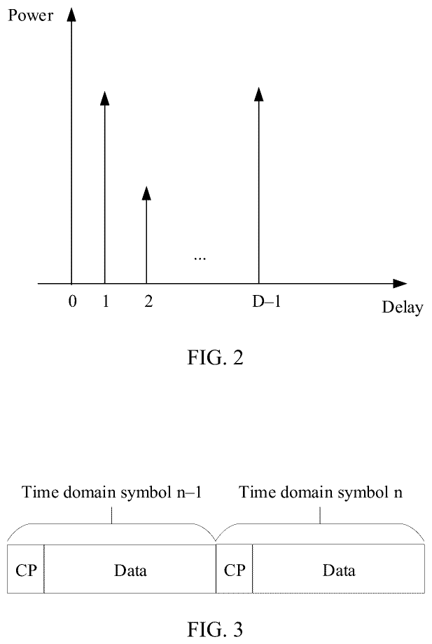

The power delay profile (PDP) is a relationship between a power of a signal received by a receive end and a delay. Usually, in a communication system, it may be assumed that a channel multipath delay is perfectly sampled, e.g., it is assumed that a sampling rate of the system is large enough, to perfectly distinguish between channel multipath delays. FIG. 2 is a diagram of channel multipath delay distribution, e.g., the power delay profile.

The power delay profile shown in FIG. 2 may be understood as follows: There are D propagation paths on the radio channel, different propagation paths correspond to different delays, and powers of signals received by the receive end through different propagation paths are also different.

### (6) Reference Signal

A network device and a terminal device may communicate with each other through a control channel and/or a data channel. The control channel may be, for example, a physical downlink control channel (PDCCH) or a physical uplink control channel (PDCCH), and the data channel may be, for example, a physical uplink shared channel (PUSCH) or a physical downlink shared channel (PDSCH).

The control channel or the data channel may carry the reference signal. For example, the reference signal may be a demodulation reference signal (DMRS), a channel state information reference signal (CSI-RS), a sounding reference signal (SRS), a tracking reference signal (TRS), a primary synchronization signal (PSS), a secondary synchronization signal (SSS), or a random access signal.

It may be understood that the foregoing uses the control channel and the data channel as an example. The network device and the terminal device may further communicate with each other via another channel, for example, a physical broadcast channel (PBCH).

### (7) Modulation and Coding Scheme

Usually, the network device may indicate the modulation and coding scheme (MCS) to the terminal device, so that the network device and the terminal device may perform uplink communication and/or downlink communication based on the MCS.

The network device may indicate the MCS to the terminal device in a plurality of manners. In an embodiment, the network device may send indication information 1 and indication information 2 to the terminal device. The indication information 1 may indicate a target MCS table, and the indication information 2 may indicate a target MCS in the target MCS table. For example, the indication information 2 includes an index value of the target MCS. Further, the terminal device selects the target MCS table from a plurality of MCS tables based on the indication information 1, and determines the target MCS from the target MCS table based on the indication information 2. The target MCS table may include a plurality of MCS indexes (for example, an MCS index 0 to an MCS index 27), and each MCS index may correspond to one modulation order and one target bit rate. For example, if a target MCS index value included in the indication information 2 is 18, the terminal device may determine that the target MCS is the MCS 18. For example, a modulation order corresponding to the MCS 18 is 4, a target bit rate corresponding to the MCS 18 is 490, and the MCS 18 may also be denoted as an MCS (4, 490).

In the communication system shown in FIG. 1, communication between the network device and the terminal device is used as an example. A signal transmit end may be the terminal device, and a signal receive end may be the network device, or the signal transmit end may be the network device, and the signal receive end may be the terminal device. The following uses an example in which “the signal transmit end is the terminal device, and the signal receive end is the network device” for description. A waveform used for communication between the network device and the terminal device may be a multicarrier waveform, or may be a single carrier waveform. The following separately describes the multicarrier waveform and the single carrier waveform.

A multicarrier means that transmit signals are arranged in parallel to form a transmit signal through an IFFT. A single carrier means that serially arranged transmit signals is convolved with a roll-off filter to form a transmit signal.

### (1) Multicarrier Waveform

When the network device and the terminal device communicate with each other through the multicarrier waveform, the transmit end (for example, the terminal device) arranges transmit signals in parallel, and forms a transmit signal through an IFFT.

FIG. 3 is a diagram of an example structure of a time domain symbol when the network device and the terminal device communicate with each other through the multicarrier waveform. As shown in FIG. 3, a time domain symbol n includes a data symbol sequence, and a CP of the data symbol sequence is included between the time domain symbol n and a time domain symbol n−1.

The following briefly describes a reason for adding a CP. In a radio channel, multipath delay and fading cause inter-symbol interference ISI at the signal receive end. To eliminate ISI between time domain symbols, a guard interval is usually inserted between the time domain symbols, and when a length of the guard interval in time domain is greater than a maximum multipath delay in the channel, the guard interval may be further used by a receiver to perform symbol timing synchronization while symbols that pass through a multipath channel do not interfere with each other, to reduce a timing error. However, the guard interval usually does not include any information. As a result, a signal on which delay spread is performed does not maintain orthogonal between subcarriers at the receive end, and inter-subcarrier interference is caused, which affects correct signal demodulation. To reduce inter-channel interference (ICI) or inter-carrier interference (ICI) caused while the ISI is eliminated, it may be considered that the cyclic prefix is filled in the guard interval. For example, a symbol sequence at the end of each time domain symbol is copied to the beginning of the time domain symbol, to form a guard interval that includes transmission information. In this way, subcarriers at the receive end can be orthogonal to each other, and correct demodulation of data is not affected.

### (2) Single Carrier Waveform

For example, the single carrier waveform may be a single carrier quadrature amplitude modulation (SC-QAM) waveform, and the multicarrier waveform may be an orthogonal frequency division multiplexing (OFDM) waveform. In addition, a discrete Fourier transform-spread-orthogonal frequency division multiplexing (DFT-s-OFDM) waveform is almost equivalent to the conventional single carrier waveform. However, the discrete Fourier transform-spread-orthogonal frequency division multiplexing waveform uses an embodiment of the multicarrier, and therefore is easy to be compatible with OFDM, but is still the single carrier waveform in essence.

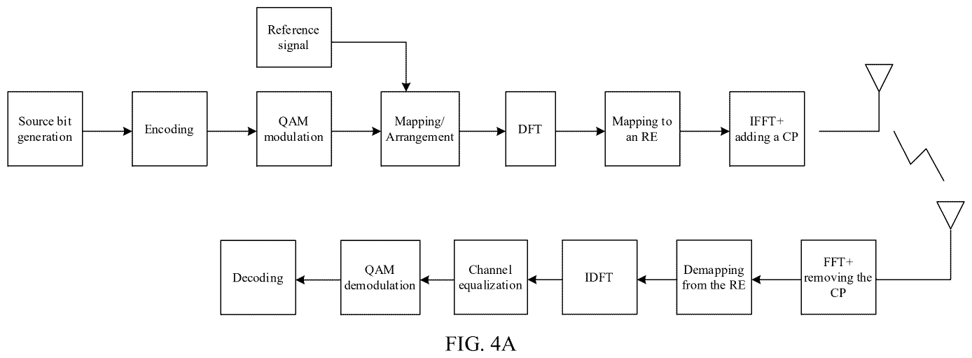

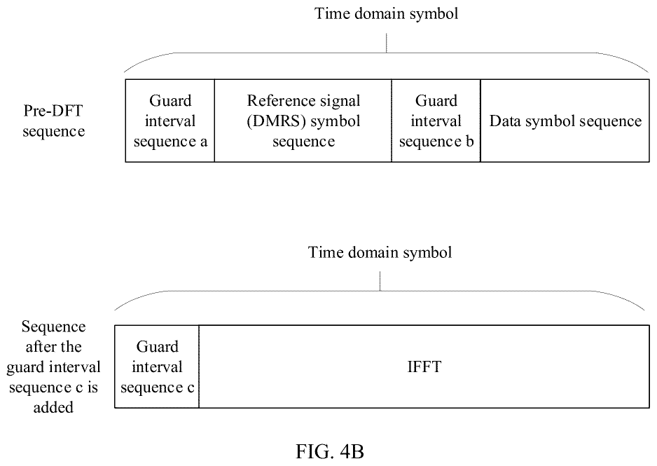

In this embodiment of this application, the DFT-s-OFDM waveform is used as an example for description. FIG. 4A is a diagram of an example signal processing procedure of the network device and the terminal device when the network device and the terminal device communicate with each other through the DFT-s-OFDM waveform.

As shown in FIG. 4A, the terminal device generates a source bit (e.g., a data bit stream), encodes the source bit, and performs QAM modulation on a bit obtained after encoding to obtain a modulated data symbol sequence. The terminal device may map/arrange a generated reference signal symbol sequence and the modulated data symbol sequence, and perform a DFT operation (which may also be referred to as transform precoding) on sequences obtained after mapping/arrangement. To be specific, the terminal device inserts a reference signal symbol into a pre-DFT time domain symbol, so that a reference signal and data are multiplexed into a time domain symbol in a time-division manner. Post-DFT sequences are mapped to a resource element (RE) (e.g., mapped to a specified frequency domain resource), the IFFT is performed, and the CP is further added to obtain a final symbol sequence. Then, the final symbol sequence is sent to the network device through a channel.

The network device performs a process inverse to that performed by the terminal device. To be specific, after receiving the symbol sequence from the terminal device, the network device removes the added CP (e.g., discards a signal outside an FFT receive window) from the symbol sequence, and performs an FFT. Then, the network device performs demapping from the RE and channel equalization, and performs an IDFT (which may also be referred to as inverse transform precoding) on a sequence for which channel equalization is completed. Then, the network device performs QAM demodulation and decoding, to restore the data bit stream sent by the terminal device.

It may be understood that the related operations in FIG. 4A are merely used as an example. In an embodiment, other operations may be further included, for example, at least one of frequency domain spectrum shaping, serial-to-parallel conversion, parallel-to-serial conversion, digital-to-analog converter (DAC), power amplifier (PA), low noise amplifier (LNA), and analog-to-digital converter (ADC).

FIG. 4B is a diagram of an example structure of a time domain symbol when the network device and the terminal device communicate with each other through the single carrier waveform. As shown in FIG. 4B, a pre-DFT sequence includes a symbol sequence a. The symbol sequence a may include a reference signal symbol sequence and a data symbol sequence, and further include at least one guard interval sequence (for example, a guard interval sequence a and a guard interval sequence b). The guard interval sequence a may include a CP and/or a CS (for example, in FIG. 4B, the CP is used as an example for illustration) of the reference signal symbol sequence. The guard interval sequence b may include a CP and/or a CS (for example, in FIG. 4B, the CP is used as an example for illustration) of the data symbol sequence. In addition, after the DFT, mapping to the RE, and IFFT are performed, a guard interval sequence c may be further added. In other words, the finally sent time domain symbol may include the guard interval sequence c.

For a multicarrier system, currently, a length of a guard interval sequence (e.g., a CP) is defined in a protocol. For example, when an IFFT length is 2048, the length of the guard interval sequence (e.g., the CP) may be 144. For another example, when an IFFT length is 1024, the length of the guard interval sequence (e.g., the CP) may be 72. In other words, the length of the guard interval sequence (e.g., the CP) may be related to the IFFT length.

For a single carrier waveform, a length of a guard interval sequence (e.g., the guard interval sequence c in FIG. 4B) between time domain symbols may still be the length of the guard interval sequence in the multicarrier system. However, how to determine a length of the guard interval sequence in the time domain symbol needs to be further studied.

Based on this, embodiments of this application provide a communication method, used to determine the length of the guard interval sequence in the time domain symbol based on a first parameter, which helps reduce multipath delay interference in the single carrier system and improve transmission performance of the single carrier system.

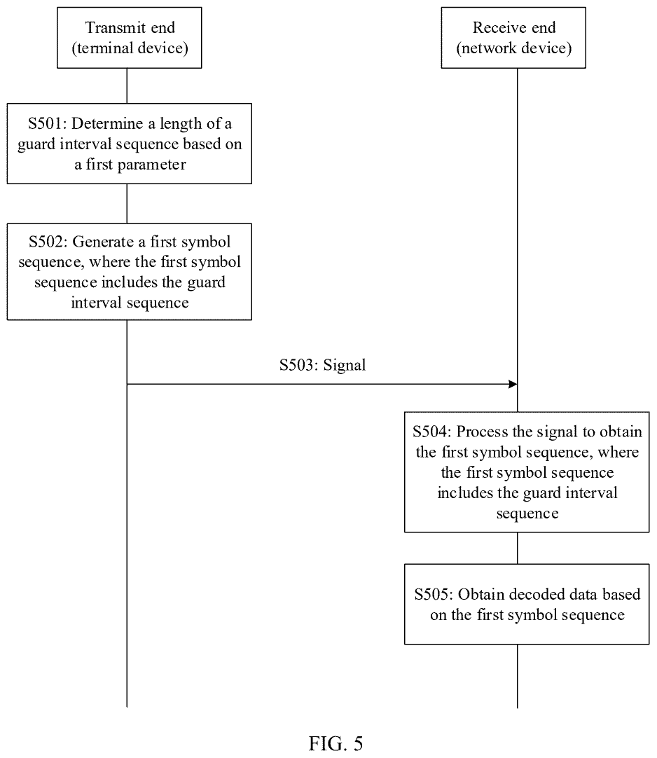

The following describes in detail the communication method provided in embodiments of this application with reference to FIG. 5. It may be understood that the technical solutions provided in embodiments of this application may be applied to wireless communication between communication devices. Wireless communication between the communication devices may include: wireless communication between a network device and a terminal device, wireless communication between network devices, and wireless communication between terminal devices. In embodiments of this application, an example in which the communication method is applied to wireless communication between a network device and a terminal device (the terminal device is the transmit end, and the network device is the receive end) is used. For other scenarios in which the communication method is applied, refer to this example.

FIG. 5 is a schematic flowchart corresponding to the communication method according to an embodiment of this application. As shown in FIG. 5, the method includes the following operations.

S501: The terminal device determines the length of the guard interval sequence based on the first parameter.

For example, the first parameter may include at least one of the following: a number of valid subcarriers in a scheduled bandwidth, an IFFT length, an MCS, and a ratio of a number of occupied subcarriers to the number of valid subcarriers.

The following describes, based on Example 1 and Example 2, an embodiment in which the terminal device determines the length of the guard interval sequence based on the first parameter.

### (1) Example 1

The terminal device may determine the length of the guard interval sequence based on a first length, the number of valid subcarriers, and the IFFT length. The first length is a first preset value, the first preset value is a positive integer, and the first preset value may be predefined in a protocol or preconfigured by the network device. Alternatively, the first length is determined based on the IFFT length. For example, when the IFFT length is 2048, the first length is 144; or when the IFFT length is 1024, the first length is 72.

For example, the length of the guard interval sequence satisfies the following formula: L=floor(a*M/N) or L=ceiling(a*M/N).

L represents the length of the guard interval sequence, a represents the first length, M represents the number of valid subcarriers, N represents the IFFT length, ceiling represents rounding up, and floor represents rounding down.

For example, if a=144, M=256, and N=2048, L=ceiling(144*256/2048)=18.

It may be understood that a correspondence between the length of the guard interval sequence (e.g., the CP) and the IFFT length is defined in the multicarrier system, and compared with the multicarrier system, a signal processing procedure at the transmit end in the single carrier system typically uses a shaped pulse and is accompanied by oversampling. Therefore, when “the first length is determined based on the IFFT length”, the foregoing manner is: dividing the length of the guard interval sequence defined in the multicarrier system by an oversampling factor to obtain the length of the guard interval sequence in the time domain symbol of the single carrier system, to reduce multipath delay interference.

### (2) Example 2

The terminal device may determine the length of the guard interval sequence based on a first length, the number of valid subcarriers, the IFFT length, and an extension length. The extension length may be a second preset value, the second preset value is a positive integer, for example, the second preset value may be 1, 2, or 3, and the second preset value may be predefined in a protocol or preconfigured by the network device. Alternatively, the terminal device may determine the extension length based on at least one of a ratio of the number of valid subcarriers to the IFFT length, the MCS, and the ratio of the number of occupied subcarriers to the number of valid subcarriers, and then determine the length of the guard interval sequence based on the first length, the number of valid subcarriers, the IFFT length, and the extension length.

For example, the length of the guard interval sequence satisfies the following formula: L=floor(a*M/N)+2Q or L=ceiling(a*M/N)+2Q.

Q represents the extension length. For other parameters, refer to the foregoing description.

For example, if a=144, M=256, N=2048, and Q=2, L=ceiling(144*256/2048)+2*2=22.

The following describes an embodiment in which the terminal device determines the extension length.

For example, the terminal device may determine the extension length based on the MCS. For example, a correspondence between the MCS and the extension length may be predefined. Table 1 shows an example of a correspondence. Further, the terminal device may determine the extension length based on an actually used MCS and the correspondence shown in Table 1.

TABLE 1
Example of the correspondence between
the MCS and the extension length

| MCS index | Extension length |
|---|---|
| [x1, x2) | 1 |
| [x2, x3) | 2 |
| Greater than or equal to x3 | 4 |

x1, x2, and x3 in Table 1 represent MCS index values. For example, x1 is 0, x2 is 9, and x3 is 18.

For another example, the terminal device may determine the extension length based on the ratio of the number of occupied subcarriers to the number of valid subcarriers (or a roll-off factor, where, as described above, the roll-off factor is equal to the number of occupied subcarriers/the number of valid subcarriers-1). For example, a correspondence between the roll-off factor and the extension length may be predefined. Table 2 shows an example of a correspondence. Further, the terminal device may determine the extension length based on an actually used roll-off factor and the correspondence shown in Table 2.

TABLE 2
Example of the correspondence between the
roll-off factor and the extension length

| Roll-off factor | Extension length |
|---|---|
| Greater than or equal to y3 | 1 |
| [y2, y3) | 2 |
| [y1, y2) | 4 |

y1, y2, and y3 in Table 2 represent roll-off factor values. For example, y1 is 0.1, y2 is 0.2, and y3 is 0.3.

For another example, the terminal device may determine the extension length based on the ratio of the number of valid subcarriers to the IFFT length (or an oversampling factor, where as described above, the oversampling factor is equal to a ratio of the IFFT length to the number of valid subcarriers). For example, a correspondence between the oversampling factor and the extension length may be predefined. Table 3 shows an example of a correspondence. Further, the terminal device may determine the extension length based on an actually used oversampling factor and the correspondence shown in Table 3.

TABLE 3
Example of the correspondence between the oversampling
factor and the extension length

| Oversampling factor | Extension length |
|---|---|
| [z1, z2) | 1 |
| [z2, z3) | 2 |
| Greater than or equal to z3 | 4 |

z1, z2, and z3 in Table 2 represent oversampling factor values. For example, z1 is 2, z2 is 4, and z3 is 8.

It may be understood that Table 1 to Table 3 show only three extension lengths (e.g., 1, 2, and 4), and the extension length may alternatively be another positive integer. This is not limited. The foregoing Table 1 to Table 3 are described separately from perspectives of the MCS, the roll-off factor, and the oversampling factor. In another example, the extension length may be determined in combination with at least two parameters of the MCS, the roll-off factor, and the oversampling factor. For example, a correspondence between the extension length and the at least two parameters of the MCS, the roll-off factor, and the oversampling factor is predefined, as shown in Table 4.

TABLE 4
Example of the correspondence between the MCS,
the roll-off factor, and the extension length

| MCS index | Roll-off factor | Extension length |
|---|---|---|
| [x11, x12) | [y11, y12) | 1 |
| [x21, x22) | [y21, y22) | 2 |
| . . . | . . . | . . . |

In addition, for an embodiment of determining the extension length based on Table 4, refer to the descriptions of Table 1 to Table 3. Details are not described again.

Compared with the manner in Example 1, the manner in Example 2 introduces the extension length. A reason why the extension length is introduced is explained herein.

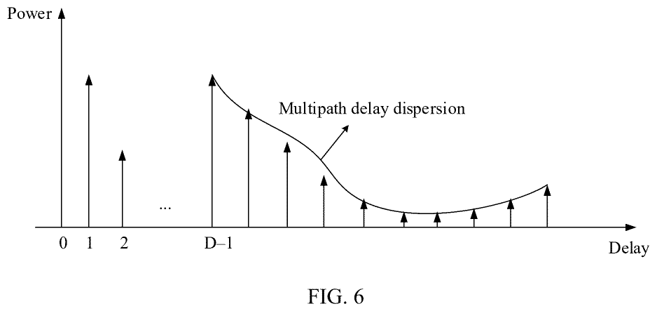

Compared with the multicarrier system, a signal processing procedure at the transmit end in the single carrier system usually uses a shaping pulse, and is accompanied by oversampling. Therefore, the receive end needs to perform corresponding undersampling. When channel multipath delay distribution is shown in FIG. 2, and the receive end may perform, during undersampling, convolution on the multipath delay distribution in FIG. 2 and an undersampling function (for example, a sinc function), to obtain multipath delay distribution under the scheduled bandwidth, as shown in FIG. 6. It can be seen from FIG. 6 that the channel multipath delay distribution, unlike that in FIG. 2, is not in a single range (corresponding to a length D in FIG. 2), but is dispersed in an entire delay domain. Therefore, for a multipath delay dispersion phenomenon (as shown in FIG. 6) in the single carrier system, in embodiments of this application, the extension length is introduced to further increase the length of the guard interval sequence (in consideration of forward dispersion and backward dispersion, the extension length may be increased by two times, e.g., 2Q), which helps reduce interference caused by multipath delay dispersion.

Further, because the channel multipath delay is dispersed in the entire delay domain, a longer length of the guard interval sequence indicates better effect of reducing multipath delay interference. However, meanwhile, this causes a decrease in resource utilization. Therefore, in embodiments of this application, the extension length may be determined based on an energy proportion (or an energy loss that the channel can tolerate), which helps reduce multipath delay interference while ensuring resource utilization.

For example, the sinc function is as follows

$$f ( n ) = \frac{1}{\sqrt{N}} \frac{sin ( π Mn / N )}{sin ( π n / N )} {e}^{i π \frac{( M - 1 ) n}{N}}$$

ƒ(n) represents the sinc function, M represents the number of valid subcarriers, N represents the IFFT length, and a value of n is 0, ±1, ±2, . . . , and ±(N/2−1).

When the extension length is 1 (e.g., Q=1), the energy proportion is a ratio of [f(0)+f(−1)+f(1)] to total energy, and the total energy is [f(−N/2−1)+ . . . +f(−2)+f(−1)+f(0)+f(1)+f(2)+ . . . +f(N/2−1)]; when the extension length is 2 (e.g., Q=2), the energy proportion is a ratio of [f(−2)+f(−1)+f(0)+f(1)+f(2)] to the total energy; when the extension length is 4 (e.g., Q=4), the energy proportion is a ratio of [f(−4)+f(−3)+f(−2)+f(−1)+f(0)+f(1)+f(2)+f(3)+f(4)] to the total energy; and so on.

It is assumed that when the extension length is 1 (e.g., Q=1), the energy proportion obtained through calculation is 90%; when the extension length is 2 (e.g., Q=2), the energy proportion obtained through calculation is 95%; and when the extension length is 4 (e.g., Q=4), the energy proportion obtained through calculation is 98%. The MCS is used as an example. If the MCS index is [x1, x2), and the energy loss that the channel can tolerate is 10% (about 0.45 decibel (dB)), the extension length corresponding to [x1, x2) may be set to 1; if the MCS index is [x2, x3), and the energy loss that the channel can tolerate is 5% (about 0.22 dB), the extension length corresponding to [x2, x3) may be set to 2; and if the MCS index is greater than or equal to x3, and the energy loss that the channel can tolerate is 2% (about 0.08 dB), the extension length corresponding to the MCS index greater than or equal to x3 may be set to 4, as shown in Table 1. For example, when the MCS index corresponding to the channel varies, the energy loss that the channel can tolerate differs. Therefore, the extension length may be determined based on the energy loss that the channel can tolerate, which helps reduce multipath delay interference while ensuring resource utilization. Herein, the MCS is used as an example. For the roll-off factor and the oversampling factor, refer to processing. Details are not described again.

It may be understood that Example 1 and Example 2 are merely two embodiments. In another example, the terminal device may alternatively determine the length of the guard interval sequence based on the number of valid subcarriers. For example, the length of the guard interval sequence satisfies the following formula: L=floor(a*x) or L=ceiling(a*x)+2Q.

a represents the first length, x represents a coefficient corresponding to the number of valid subcarriers, and Q represents the extension length. In this case, the first length may be predefined as the first preset value, the extension length may be predefined as the second preset value, and a correspondence between the number of valid subcarriers and the coefficient x is predefined, so that the terminal device can determine the coefficient x based on the number of valid subcarriers, and determine the length of the guard interval sequence.

Alternatively, the terminal device may determine the length of the guard interval sequence based on the IFFT length. For example, the length of the guard interval sequence satisfies the following formula: L=floor(a*y) or L=ceiling(a*y)+2Q.

a represents the first length, y represents a coefficient corresponding to the IFFT length, and Q represents the extension length. In this case, the first length may be predefined as the first preset value, the extension length may be predefined as the second preset value, and a correspondence between the IFFT length and the coefficient y is predefined, so that the terminal device can determine the coefficient y based on the IFFT length, and further determine the length of the guard interval sequence.

Alternatively, the terminal device may determine the length of the guard interval sequence based on the MCS. For example, the length of the guard interval sequence satisfies the following formula: L=K+2Q.

K represents a third preset value (the third preset value may be predefined in a protocol or preconfigured by the network device), and Q represents the extension length. In this case, the correspondence between the MCS and the extension length may be predefined, as shown in Table 1, so that the terminal device can determine the extension length based on the MCS, and further determine the length of the guard interval sequence. The MCS is used as an example herein. The MCS may be replaced with the ratio of the number of valid subcarriers to the IFFT length or the ratio of the number of occupied subcarriers to the number of valid subcarriers. Details are not described again.

S502: The terminal device generates a first symbol sequence, where the first symbol sequence includes the guard interval sequence, and the first symbol sequence is a symbol sequence prior to transform precoding.

For example, the first symbol sequence further includes a second symbol sequence, and the second symbol sequence is either a reference signal symbol sequence or a data symbol sequence. In other words, the second symbol sequence may be the reference signal symbol sequence, or may be the data symbol sequence. The guard interval sequence is a first guard interval sequence, the guard interval sequence is a second guard interval sequence, or the guard interval sequence includes the first guard interval sequence and the second guard interval sequence. The first guard interval sequence is located before the second symbol sequence and the second guard interval sequence is located after the second symbol sequence.

The guard interval sequence, the first guard interval sequence, or the second guard interval sequence may be a specific sequence or a predefined sequence, for example, a sequence with all 0s or a sequence with all 1s; or may be a cyclic sequence of the second symbol sequence, for example, the first guard interval sequence is a cyclic prefix sequence of the second symbol sequence, and the second guard interval sequence is a cyclic suffix sequence of the second symbol sequence.

With reference to Embodiment 1 and Embodiment 2, the following describes a length of the first guard interval sequence and a length of the second guard interval sequence when the guard interval sequence includes the first guard interval sequence and the second guard interval sequence.

### (1) Embodiment 1

The terminal device may first determine the length of the guard interval sequence (for example, the manner described in S501), and then flexibly allocate the length of the first guard interval sequence and the length of the second guard interval sequence based on the length of the guard interval sequence. A sum of the length of the first guard interval sequence and the length of the second guard interval sequence is equal to the length of the guard interval sequence. For example, the length of the first guard interval sequence or the length of the second guard interval sequence that is allocated by the terminal device is less than or equal to 2Q.

For example, the length of the first guard interval sequence or the length of the second guard interval sequence may satisfy the following formula: L′=2Q−p.

L′ represents the length of the first guard interval sequence, and in this case, the length of the second guard interval sequence is L-L′. Alternatively, L′ represents the length of the second guard interval sequence, and in this case, the length of the first guard interval sequence is L-L′. Q represents the extension length, p is less than or equal to 2Q, and p is an integer greater than or equal to 0.

As described above, in embodiments of this application, the length of the guard interval sequence is further increased by adding 2Q, and the length of the first guard interval sequence or the length of the second guard interval sequence is allocated in the foregoing manner (e.g., the length of the first guard interval sequence or the length of the second guard interval sequence is less than or equal to 2Q), which helps effectively reduce multipath delay interference.

### (2) Embodiment 2

The terminal device may separately determine the length of the first guard interval sequence and the length of the second guard interval sequence. For example, the terminal device may determine the length of the first guard interval sequence based on the first length, the number of valid subcarriers, the IFFT length, and the extension length, and determine the length of the second guard interval sequence based on the extension length. For example, the length of the first guard interval sequence and the length of the second guard interval sequence satisfy the following formulas: L1=floor(a*M/N)+Q or L1=ceiling(a*M/N)+Q, and L2=Q.

L1 represents the length of the first guard interval sequence, and L2 represents the length of the second guard interval sequence. For meanings of other parameters, refer to the foregoing description.

Alternatively, the terminal device may determine the length of the second guard interval sequence based on the first length, the number of valid subcarriers, the IFFT length, and the extension length, and determine the length of the first guard interval sequence based on the extension length. For example, L1 represents the length of the second guard interval sequence, and L2 represents the length of the first guard interval sequence.

It may be understood that Embodiment 2 is merely an example. In another example, the terminal device may alternatively determine the length of the first guard interval based on the first length, the number of valid subcarriers, and the IFFT length, and determine the length of the second guard interval based on the extension length. For example, the length of the first guard interval sequence and the length of the second guard interval sequence satisfy the following formulas: L1=floor(a*M/N) or L1=ceiling(a*M/N), and L2=2Q.

L1 represents the length of the first guard interval sequence, and L2 represents the length of the second guard interval sequence. For meanings of other parameters, refer to the foregoing description.

Alternatively, the terminal device may determine the length of the second guard interval sequence based on the first length, the number of valid subcarriers, and the IFFT length, and determine the length of the first guard interval sequence based on the extension length. For example, L1 represents the length of the second guard interval sequence, and L2 represents the length of the first guard interval sequence.

S503: The terminal device sends a signal to the network device, and correspondingly, the network device receives the signal.

For example, the terminal device may output the first symbol sequence, process the first symbol sequence to obtain the third symbol sequence and a cyclic prefix sequence of the third symbol sequence, and then send a signal to the network device. The signal includes the third symbol sequence and the cyclic prefix sequence of the third symbol sequence. For example, the processing on the first symbol sequence may include transform precoding, mapping to an RE, an IFFT, and adding the cyclic prefix sequence of the third symbol sequence. A length of the cyclic prefix sequence of the third symbol sequence may follow that in the conventional technology. For example, when the IFFT length is 2048, the length of the cyclic prefix of the third symbol sequence is 144.

In an embodiment, the terminal device may further send other information to the network device, for example, send first indication information and/or second indication information.

### (1) First Indication Information

The first indication information indicates the length of the guard interval sequence. For example, when the guard interval sequence includes the first guard interval sequence and the second guard interval sequence, the first indication information indicates the length of the first guard interval sequence and/or the length of the second guard interval sequence.

An example in which the first indication information indicates the length of the guard interval sequence is used. There may be a plurality of specific indication manners. For example, the first indication information may include an index value of the length of the guard interval sequence. A specific indication manner is not limited in embodiments of this application.

### (2) Second Indication Information

The second indication information indicates an advance amount or a delay amount of a receive window of the second symbol sequence, and the advance amount or the delay amount is determined based on the length of the first guard interval sequence or the length of the second guard interval sequence, and the extension length. The receive window is used by the receive end (for example, the network device) to take the second symbol sequence after inverse transform precoding.

An example in which the first guard interval sequence is a cyclic prefix sequence of a reference signal (for example, a DMRS) symbol sequence, and the second guard interval sequence is a cyclic suffix sequence of the reference symbol sequence. The following describes several cases (e.g., Case 1 to Case 4).

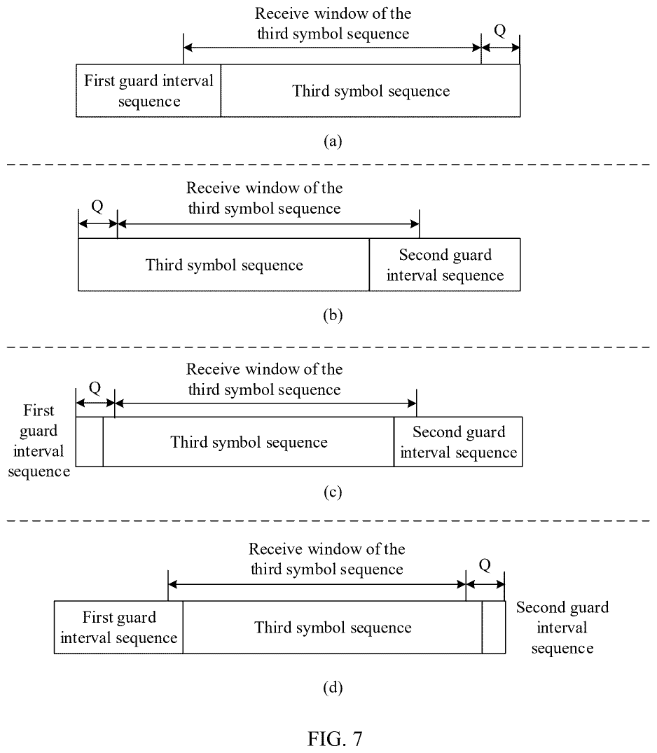

Case 1: When the guard interval sequence is the first guard interval sequence, the second indication information indicates that the advance amount of the receive window is Q, as shown in (a) in FIG. 7. In this case, advancing the receive window can reduce interference caused by backward dispersion.

Case 2: When the guard interval sequence is the second guard interval sequence, the second indication information indicates that the delay amount of the receive window is Q, as shown in (b) in FIG. 7. In this case, delaying the receive window can reduce interference caused by forward dispersion.

Case 3: When the guard interval sequence includes the first guard interval sequence and the second guard interval sequence, if the length (for example, represented as L1) of the first guard interval sequence is less than Q, the second indication information indicates the delay amount of the receive window of the second symbol sequence, and the delay amount is equal to Q-L 1, as shown in (c) in FIG. 7.

Case 4: When the guard interval sequence includes the first guard interval sequence and the second guard interval sequence, if the length (for example, represented as L2) of the second guard interval sequence is less than Q, the second indication information indicates the advance amount of the receive window of the second symbol sequence, and the advance amount is equal to Q−L2, as shown in (d) in FIG. 7.

In other words, L′=2Q−p. When L′ represents the length of the first guard interval sequence, if p is greater than Q, the second indication information indicates that the delay amount of the receive window is p−Q; or if p is less than Q, the second indication information indicates that the advance amount of the receive window is Q−p. When L′ represents the length of the second guard interval sequence, if p is greater than Q, the second indication information indicates that the advance amount of the receive window is p−Q; or if p is less than Q, the second indication information indicates that the delay amount of the receive window is Q−p. When p=Q, the receive window may not be advanced, or may not be delayed.

In addition, the first indication information and/or the second indication information may be carried in uplink control information (UCI) or another message. This is not limited.

S504: The network device processes the signal to obtain the first symbol sequence, where the first symbol sequence includes the guard interval sequence.

For example, the signal may include the third symbol sequence and the cyclic prefix sequence of the third symbol sequence. The network device may remove the cyclic prefix sequence of the third symbol sequence, and perform the FFT, demapping from the RE, and transform precoding on the third symbol sequence to obtain the first symbol sequence.

S505: The network device obtains decoded data based on the first symbol sequence.

For example, the network device may determine an advance amount or a delay amount of a receive window of the third symbol sequence based on the extension length, and the length of the first symbol sequence and/or the length of the second symbol sequence that are/is indicated by the first indication information. For a specific determining manner, refer to the foregoing description of determining the advance amount or the delay amount by the terminal device. Details are not described again. Alternatively, the network device may directly determine the advance amount or the delay amount of the receive window of the third symbol sequence based on the second indication information.

Further, the network device may take the second symbol sequence (for example, the second symbol sequence is a data symbol sequence) from the first symbol sequence based on the receive window of the third symbol sequence, to obtain the decoded data.

The following describes a processing procedure on a network device side with reference to a specific example. It is assumed that a sample (e.g., the IFFT length) of the terminal device after sampling is 1024, and the number of valid subcarriers is 256. After receiving the 1024 sample of a time domain signal, the network device may perform the FFT of the 1024 sample, then perform demapping from the RE to restore received frequency domain data of a 256 sample, and perform an IDFT of a 256 sample to obtain a pre-DFT time domain sequence (e.g., the first symbol sequence). Further, the network device may take the reference signal symbol sequence based on a receive window of a reference signal (for example, a DMRS) and take the data symbol sequence based on a receive window of data; and further, perform channel estimation based on the DMRS symbol sequence, and decode the data symbol sequence based on a channel estimation result to obtain the decoded data.

It may be understood that the foregoing is described by using an example in which the guard interval sequence is a cyclic sequence of the reference signal symbol sequence or a cyclic sequence of the data symbol sequence. In another example, the reference signal symbol sequence and the data symbol sequence may have respective cyclic sequences. For embodiment of both a length of the cyclic sequence of the reference signal symbol sequence and a length of the cyclic sequence of the data symbol sequence, refer to the length of the guard interval sequence. Alternatively, as shown in FIG. 4B, the time domain symbol may include a plurality of guard interval sequences (for example, the guard interval sequence a and the guard interval sequence b). The foregoing uses one guard interval sequence in the time domain symbol as an example for description. When the time domain symbol includes a plurality of guard interval sequences, lengths of the plurality of guard interval sequences (for example, the guard interval sequence a and the guard interval sequence b) may be determined in the manner described above.

In addition, an example in which the terminal device is the transmit end and the network device is the receive end is used for description. In another example, the network device may be the transmit end, and the terminal device may be the receive end. In this case, the first indication information and/or the second indication information may be carried in downlink control information (DCI) or another message. This is not limited.

The foregoing mainly describes, from the perspective of interaction between the network device and the terminal device, the solutions provided in embodiments of this application. It may be understood that to implement the foregoing functions, the network device and the terminal device may include corresponding hardware structures and/or software modules for performing the functions. A person skilled in the art should be easily aware that, in combination with units and algorithm operations of the examples described in embodiments disclosed in this specification, embodiments of this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, the network device and the terminal device may be divided into functional units based on the foregoing method examples. For example, each functional unit may be obtained through division based on each corresponding function, or two or more functions may be integrated into one unit. The integrated unit may be implemented in a form of hardware, or may be implemented in a form of a software functional unit.

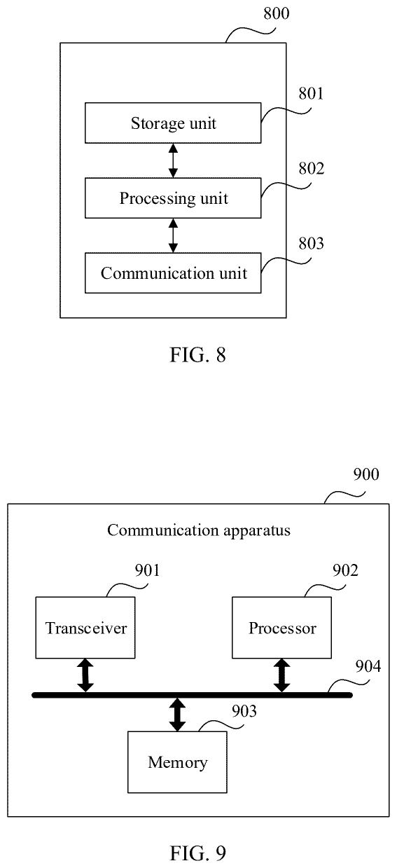

When an integrated unit is used, FIG. 8 is an example block diagram of an apparatus according to an embodiment of this application. As shown in FIG. 8, the apparatus 800 may include a processing unit 802 and a communication unit 803. The processing unit 802 is configured to control and manage an action of the apparatus 800. The communication unit 803 is configured to support communication between the apparatus 800 and another device. In an embodiment, the communication unit 803 is also referred to as a transceiver unit, and may include a receiving unit and/or a sending unit, respectively configured to perform a receiving operation and a sending operation. The apparatus 800 may further include a storage unit 801, configured to store program code and/or data of the apparatus 800.

(1) The apparatus 800 may be the transmit end (for example, the terminal device) in the foregoing embodiment. The processing unit 802 may support the apparatus 800 in performing actions of the terminal device in the foregoing method examples. Alternatively, the processing unit 802 mainly performs internal actions of the terminal device in the method examples, and the communication unit 803 may support communication between the apparatus 800 and another device.

For example, in an embodiment, the processing unit 802 is configured to: determine a length of a guard interval sequence based on a first parameter, where the first parameter includes at least one of the following: a number of valid subcarriers in a scheduled bandwidth, an inverse fast Fourier transform IFFT length, a modulation and coding scheme MCS, and a ratio of a number of occupied subcarriers to the number of valid subcarriers; generate a first symbol sequence, where the first symbol sequence includes the guard interval sequence, and the first symbol sequence is a symbol sequence prior to transform precoding; and output the first symbol sequence.

In an embodiment, the processing unit 802 is further configured to: process the first symbol sequence to obtain a third symbol sequence and a cyclic prefix sequence of the third symbol sequence; and output the third symbol sequence and the cyclic prefix sequence of the third symbol sequence, where the processing includes transform precoding, an IFFT, and adding the cyclic prefix sequence of the third symbol sequence.

In an embodiment, the processing unit 802 is configured to determine the length of the guard interval sequence based on a first length, the number of valid subcarriers, the IFFT length, and an extension length. The first length is a first preset value, or the first length is determined based on the IFFT length. The extension length is a second preset value, or the extension length is determined based on at least one of the following: the MCS, a ratio of the number of valid subcarriers to the IFFT length, and the ratio of the number of occupied subcarriers to the number of valid subcarriers.

In an embodiment, the length of the guard interval sequence satisfies the following formula: L=floor(a*M/N)+2Q or L=ceiling(a*M/N)+2Q.

L represents the length of the guard interval sequence, a represents the first length, M represents the number of valid subcarriers, N represents the IFFT length, Q represents the extension length, floor represents rounding down, and ceiling represents rounding up.

In an embodiment, the first symbol sequence further includes a second symbol sequence, and the second symbol sequence is either a reference signal symbol sequence or a data symbol sequence. The guard interval sequence is a first guard interval sequence; the guard interval sequence is a second guard interval sequence; or the guard interval sequence includes the first guard interval sequence and the second guard interval sequence. The first guard interval sequence is located before the second symbol sequence, and the second guard interval sequence is located after the second symbol sequence.

In an embodiment, the first guard interval sequence is a cyclic prefix sequence of the second symbol sequence, and the second guard interval sequence is a cyclic suffix sequence of the second symbol sequence.

In an embodiment, when the guard interval sequence includes the first guard interval sequence and the second guard interval sequence, a length of the first guard interval sequence is determined based on the first length, the number of valid subcarriers, the IFFT length, and the extension length, and a length of the second guard interval sequence is determined based on the extension length. Alternatively, the length of the second guard interval sequence is determined based on the first length, the number of valid subcarriers, the IFFT length, and the extension length, and the length of the first guard interval sequence is determined based on the extension length. The first length is a first preset value, or the first length is determined based on the IFFT length. The extension length is the second preset value, or the extension length is determined based on at least one of the following: the MCS, the ratio of the number of valid subcarriers to the IFFT length, and the ratio of the number of occupied subcarriers to the number of valid subcarriers.

In an embodiment, the communication unit 803 is configured to send first indication information, where the first indication information indicates the length of the first guard interval sequence and/or the length of the second guard interval sequence.

In an embodiment, when the guard interval sequence includes the first guard interval sequence and the second guard interval sequence, the length of the first guard interval sequence or the length of the second guard interval sequence satisfies the following formula: L′=2Q−p.

L′ represents the length of the first guard interval sequence or the length of the second guard interval sequence, Q represents the extension length, p is less than or equal to 2Q, and p is an integer greater than or equal to 0. The extension length is the second preset value, or the extension length is determined based on at least one of the following: the MCS, the ratio of the number of valid subcarriers to the IFFT length, and the ratio of the number of occupied subcarriers to the number of valid subcarriers.

In an embodiment, the communication unit 803 is configured to send second indication information, where the second indication information indicates an advance amount or a delay amount of a receive window of the second symbol sequence, and the advance amount or the delay amount is determined based on the length of the first guard interval sequence or the length of the second guard interval sequence, and the extension length; and the receive window is configured to take the second symbol sequence after inverse transform precoding.

In an embodiment, L′ represents the length of the first guard interval sequence. If p is greater than Q, the second indication information indicates that the delay amount of the receive window is p−Q. If p is less than Q, the second indication information indicates that the advance amount of the receive window is Q−p.

In an embodiment, L′ represents the length of the second guard interval sequence. If p is greater than Q, the second indication information indicates that the advance amount of the receive window is p−Q. If p is less than Q, the second indication information indicates that the delay amount of the receive window is Q−p.

(2) The apparatus 800 may be the receive end (the network device) in the foregoing embodiment. The processing unit 802 may support the apparatus 800 in performing actions of the network device in the foregoing method examples. Alternatively, the processing unit 802 mainly performs internal actions of the network device in the method examples, and the communication unit 803 may support communication between the apparatus 800 and another device.

For example, in an embodiment, the communication unit 803 is configured to receive a signal. The processing unit 802 is configured to: process the signal to obtain a first symbol sequence, where the first symbol sequence includes a guard interval sequence, a length of the guard interval sequence is determined based on a first parameter, and the first parameter includes at least one of the following: a number of valid subcarriers in a scheduled bandwidth, an IFFT length, an MCS, and a ratio of a number of occupied subcarriers to the number of valid subcarriers; and obtain decoded data based on the first symbol sequence.

In an embodiment, the first symbol sequence further includes a second symbol sequence, and the second symbol sequence is either a reference signal symbol sequence or a data symbol sequence. The guard interval sequence is a first guard interval sequence; the guard interval sequence is a second guard interval sequence; or the guard interval sequence includes the first guard interval sequence and the second guard interval sequence. The first guard interval sequence is located before the second symbol sequence, and the second guard interval sequence is located after the second symbol sequence.

In an embodiment, the first guard interval sequence is a cyclic prefix sequence of the second symbol sequence, and the second guard interval sequence is a cyclic suffix sequence of the second symbol sequence.

In an embodiment, the communication unit 803 is further configured to receive first indication information, where the first indication information indicates the length of the first guard interval sequence and/or the length of the second guard interval sequence.

In an embodiment, the communication unit 803 is further configured to receive second indication information, where the second indication information indicates an advance amount or a delay amount of a receive window of the second symbol sequence; and the receive window is configured to take the second symbol sequence after inverse transform precoding.

It should be understood that division into the units in the foregoing apparatus is merely logical function division. During actual implementation, all or a part of the units may be integrated into one physical entity, or may be physically separated. In addition, all the units in the apparatus may be implemented in a form of software invoked by a processing element, or may be implemented in a form of hardware, or some units may be implemented in a form of software invoked by a processing element, and some units may be implemented in a form of hardware. For example, each unit may be a separately disposed processing element, or may be integrated into a chip of the apparatus for implementation. In addition, each unit may alternatively be stored in a memory in a form of a program to be invoked by a processing element of the apparatus to perform a function of the unit. In addition, all or a part of the units may be integrated together, or may be implemented independently. The processing element herein may also be referred to as a processor, and may be an integrated circuit having a signal processing capability. In an embodiment, operations in the foregoing methods or the foregoing units may be implemented by using a hardware integrated logic circuit in the processor element, or may be implemented in a form in which the processing element invokes software.

In an example, a unit in any one of the foregoing apparatuses may be one or more integrated circuits configured to implement the foregoing methods, for example, one or more application-specific integrated circuits (ASIC), one or more microprocessors (DSP), one or more field programmable gate arrays (FPGA), or a combination of at least two of these forms of integrated circuits. For another example, when the units in the apparatus may be implemented in a form in which a processing element schedules a program, the processing element may be a processor, for example, a general-purpose central processing unit (CPU) or another processor that can invoke the program. For another example, the units may be integrated and implemented in a form of a SoC.

The foregoing unit configured for receiving is an interface circuit of the apparatus, and is configured to receive a signal from another apparatus. For example, when the apparatus is implemented in a form of a chip, the receiving unit is an interface circuit that is of the chip and that is configured to receive a signal from another chip or apparatus. The foregoing unit configured for sending is an interface circuit of the apparatus, and is configured to send a signal to another apparatus. For example, when the apparatus is implemented in a form of a chip, the sending unit is an interface circuit that is of the chip and that is configured to send a signal to another chip or apparatus.

Based on the foregoing embodiments, an embodiment of this application further provides a communication apparatus. As shown in FIG. 9, the communication apparatus 900 may include a transceiver 901 and a processor 902. In an embodiment, the communication apparatus 900 may further include a memory 903. The memory 903 may be disposed inside the communication apparatus 900, or may be disposed outside the communication apparatus 900. The processor 902 may control the transceiver 901 to receive and send messages and the like.

In an embodiment, the processor 902 may be a central processing unit (CPU), a network processor (NP), or a combination of a CPU and an NP. The processor 902 may further include a hardware chip. The hardware chip may be an application-specific integrated circuit (ASIC), a programmable logic device (PLD), or a combination thereof. The PLD may be a complex programmable logic device (CPLD), a field-programmable gate array (FPGA), a generic array logic (GAL), or any combination thereof.

The transceiver 901, the processor 902, and the memory 903 are connected to each other. In an embodiment, the transceiver 901, the processor 902, and the memory 903 are connected to each other through a bus 904. The bus 904 may be a peripheral component interconnect (PCI) bus, an extended industry standard architecture (EISA) bus, or the like. The bus may be classified into an address bus, a data bus, a control bus, and the like. For ease of representation, only one bold line is used for representation in FIG. 9, but this does not mean that there is only one bus or only one type of bus.

In an embodiment, the memory 903 is configured to store a program and the like. In an embodiment, the program may include program code, and the program code includes computer operation instructions. The memory 903 may include a RAM, and may further include a non-volatile memory, for example, one or more disk memories. The processor 902 executes the application program stored in the memory 903 to implement the foregoing functions, to implement functions of the communication apparatus 900.

For example, the communication apparatus 900 may be the transmit end (for example, the terminal device) in the foregoing embodiments, or may be the receive end (for example, the network device) in the foregoing embodiments.

In an embodiment, when the communication apparatus 900 implements a function of the transmit end in the foregoing method embodiments, the transceiver 901 may implement a receiving/sending operation performed by the transmit end in the foregoing method embodiments, and the processor 902 may implement an operation other than the receiving/sending operation performed by the transmit end in the foregoing method embodiments. In an embodiment, for related specific descriptions, refer to related descriptions in the foregoing embodiments. Details are not described herein again.

In another embodiment, when the communication apparatus 900 implements a function of the receive end in the foregoing method embodiments, the transceiver 901 may implement a receiving/sending operation performed by the receive end in the foregoing method embodiments, and the processor 902 may implement an operation other than the receiving/sending operation performed by the receive end in the foregoing method embodiments. In an embodiment, for related specific descriptions, refer to related descriptions in the foregoing embodiments. Details are not described herein again.

Terms “system” and “network” may be used interchangeably in embodiments of this application. “At least one” means one or more, and “a plurality of” means two or more. A term “and/or” describes an association relationship of associated objects, and indicates that three relationships may exist. For example, A and/or B may indicate the following three cases: Only A exists, both A and B exist, and only B exists, where A and B may be singular or plural. The character “/” generally indicates an “or” relationship between the associated objects. At least one of the following items (pieces) or a similar expression thereof indicates any combination of these items, including a single item (piece) or any combination of a plurality of items (pieces). For example, “at least one of A, B, or C” includes A, B, C, AB, AC, BC, or ABC, and “at least one of A, B, and C” may also be understood as including A, B, C, AB, AC, BC, or ABC. In addition, unless otherwise specified, ordinal numbers such as “first” and “second” mentioned in embodiments of this application are used to distinguish between a plurality of objects, but are not used to limit a sequence, a time sequence, priorities, or importance of the plurality of objects.

A person skilled in the art should understand that embodiments of this application may be provided as a method, a system, or a computer program product. Therefore, this application may use a form of hardware only embodiments, software only embodiments, or embodiments with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may alternatively be stored in a computer-readable memory that can instruct a computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations are performed on the computer or the other programmable device, so that computer-implemented processing is generated. Therefore, the instructions executed on the computer or the other programmable device provide operations for implementing a specific function in one or more procedures in the flowcharts and/or in one or more blocks in the block diagrams.

1. A communication method, comprising:
determining a length of a guard interval sequence based on a first parameter comprising at least one of: a number of valid subcarriers in a scheduled bandwidth, an inverse fast Fourier transform (IFFT) length, a modulation and coding scheme (MCS), or a ratio of a number of occupied subcarriers to the number of valid subcarriers;
generating a first symbol sequence comprising the guard interval sequence, wherein the first symbol sequence is a symbol sequence prior to transform precoding; and
outputting the first symbol sequence.

2. The communication method according to claim 1, wherein
determining the length of the guard interval sequence comprises:
determining the length of the guard interval sequence based on a first length, the number of valid subcarriers, the IFFT length, and an extension length;
the first length is a first preset value, or the first length is determined based on the IFFT length; and
the extension length is a second preset value, or the extension length is determined based on at least one of: the MCS, a ratio of the number of valid subcarriers to the IFFT length, or the ratio of the number of occupied subcarriers to the number of valid subcarriers.

3. The communication method according to claim 2, wherein the length of the guard interval sequence satisfies the following:
L=floor(a*M/N)+2Q or L=ceiling(a*M/N)+2Q, wherein
L represents the length of the guard interval sequence, a represents the first length, M represents the number of valid subcarriers, N represents the IFFT length, Q represents the extension length, floor represents rounding down, and ceiling represents rounding up.

4. The communication method according to claim 2, wherein
the first symbol sequence further comprises a second symbol sequence being a reference signal symbol sequence or a data symbol sequence;
the guard interval sequence is a first guard interval sequence or a second guard interval sequence; or
the guard interval sequence comprises the first guard interval sequence and the second guard interval sequence; and
the first guard interval sequence is located before the second symbol sequence, and the second guard interval sequence is located after the second symbol sequence.

5. The communication method according to claim 4, wherein
the first guard interval sequence is a cyclic prefix sequence of the second symbol sequence; and
the second guard interval sequence is a cyclic suffix sequence of the second symbol sequence.

6. The communication method according to claim 4, wherein when the guard interval sequence comprises the first guard interval sequence and the second guard interval sequence, a length of the first guard interval sequence is determined based on the first length, the number of valid subcarriers, the IFFT length, and the extension length, and a length of the second guard interval sequence is determined based on the extension length; or the length of the second guard interval sequence is determined based on the first length, the number of valid subcarriers, the IFFT length, and the extension length, and the length of the first guard interval sequence is determined based on the extension length.

7. The communication method according to claim 6, further comprising:
sending first indication information indicating the length of the first guard interval sequence or the length of the second guard interval sequence.

8. The communication method according to claim 6, wherein when the guard interval sequence comprises the first guard interval sequence and the second guard interval sequence, the length of the first guard interval sequence or the length of the second guard interval sequence satisfies the following:
L′=2Q−p, wherein
L′ represents the length of the first guard interval sequence or the length of the second guard interval sequence, Q represents the extension length, p is less than or equal to 2Q, and p is an integer greater than or equal to 0.

9. The communication method according to claim 8, further comprising:
sending second indication information indicating an advance amount or a delay amount of a receive window of the second symbol sequence, wherein the advance amount or the delay amount is determined based on the length of the first guard interval sequence or the length of the second guard interval sequence, and the extension length; and
wherein the receive window is configured to take the second symbol sequence after inverse transform precoding.

10. The communication method according to claim 9, wherein
L′ represents the length of the first guard interval sequence;
if p is greater than Q, the second indication information indicates that the delay amount of the receive window is p−Q; and
if p is less than Q, the second indication information indicates that the advance amount of the receive window is Q−p.

11. The communication method according to claim 9, wherein
L′ represents the length of the second guard interval sequence;
if p is greater than Q, the second indication information indicates that the advance amount of the receive window is p−Q; and
if p is less than Q, the second indication information indicates that the delay amount of the receive window is Q−p.

12. A communication method, comprising:
receiving a signal;
processing the signal to obtain a first symbol sequence comprising a guard interval sequence, wherein a length of the guard interval sequence is determined based on a first parameter comprising at least one of: a number of valid subcarriers in a scheduled bandwidth, an inverse fast Fourier transform (IFFT) length, a modulation and coding scheme (MCS), and a ratio of a number of occupied subcarriers to the number of valid subcarriers; and
obtaining decoded data based on the first symbol sequence.

13. The communication method according to claim 12, wherein
the first symbol sequence further comprises a second symbol sequence being a reference signal symbol sequence or a data symbol sequence;
the guard interval sequence is a first guard interval sequence or a second guard interval sequence; or
the guard interval sequence comprises the first guard interval sequence and the second guard interval sequence; and
the first guard interval sequence is located before the second symbol sequence, and the second guard interval sequence is located after the second symbol sequence.

14. The communication method according to claim 13, wherein
the first guard interval sequence is a cyclic prefix sequence of the second symbol sequence; and
the second guard interval sequence is a cyclic suffix sequence of the second symbol sequence.

15. The communication method according to claim 13, further comprising:
receiving first indication information indicating where a length of the first guard interval sequence a length of the second guard interval sequence.

16. The communication method according to claim 13, further comprising:
receiving second indication information indicating an advance amount or a delay amount of a receive window of the second symbol sequence; and
wherein the receive window is configured to take the second symbol sequence after inverse transform precoding.

17. A communication apparatus, comprising:
a processor configured to execute a computer program or computer instructions in a memory, to enable the communication apparatus to:
determine a length of a guard interval sequence based on a first parameter comprising at least one of: a number of valid subcarriers in a scheduled bandwidth, an inverse fast Fourier transform (IFFT) length, a modulation and coding scheme (MCS), or a ratio of a number of occupied subcarriers to the number of valid subcarriers;
generate a first symbol sequence comprising the guard interval sequence, wherein the first symbol sequence is a symbol sequence prior to transform precoding; and
output the first symbol sequence.

18. The communication apparatus according to claim 17, wherein
the communication apparatus to determine the length of the guard interval sequence comprises the communication apparatus to:
determine the length of the guard interval sequence based on a first length, the number of valid subcarriers, the IFFT length, and an extension length;
the first length is a first preset value, or the first length is determined based on the IFFT length; and
the extension length is a second preset value, or the extension length is determined based on at least one of: the MCS, a ratio of the number of valid subcarriers to the IFFT length, or the ratio of the number of occupied subcarriers to the number of valid subcarriers.

19. The communication apparatus according to claim 18, wherein the length of the guard interval sequence satisfies the following:
L=floor(a*M/N)+2Q or L=ceiling(a*M/N)+2Q, wherein
L represents the length of the guard interval sequence, a represents the first length, M represents the number of valid subcarriers, N represents the IFFT length, Q represents the extension length, floor represents rounding down, and ceiling represents rounding up.

20. The communication apparatus according to claim 17, wherein
the first symbol sequence further comprises a second symbol sequence being a reference signal symbol sequence or a data symbol sequence;
the guard interval sequence is a first guard interval sequence or a second guard interval sequence; or
the guard interval sequence comprises the first guard interval sequence and the second guard interval sequence; and
the first guard interval sequence is located before the second symbol sequence, and the second guard interval sequence is located after the second symbol sequence.
